(19) United States
(12) Patent Application Publication
(10) Pub. No.: US 2026/0213348 A1
(43) Pub. Date: Jul. 23, 2026

(54) BATTERY CELL

(71) Applicant: AESC JAPAN LTD., Kanagawa (JP)

(72) Inventors: Ryo SAKAMOTO, Kanagawa (JP); Takao DAIDOJI, Kanagawa (JP)

(21) Appl. No.: 19/140,031

(22) PCT Filed: Nov. 28, 2023
(86) PCT No.: PCT/JP2023/042496

§ 371 Date: Jun. 17, 2025

(30) Foreign Application Priority Data
Dec. 19, 2022 (JP) 2022-201916

(51) Int. Cl. H01M 50/466; H01M 10/04; H01M 50/103; H01M 50/46

(52) U.S. Cl. CPC H01M 50/466; H01M 10/0459; H01M 50/103; H01M 50/46

(57) ABSTRACT

The first stack (110A) includes first positive electrodes (112A) and first negative electrodes (114A) alternately stacked in a predetermined direction, and a first separator (116A) at least a part of which covers the first negative electrode (114A) located on the outermost side of the first positive electrodes (112A) and the first negative electrodes (114A) in the predetermined direction. The second stack (120A) includes second positive electrodes (122A) and second negative electrodes (124A) alternately stacked in a predetermined direction, and a second separator (126A) at least a part of which covers the second negative electrode (124A) located on the outermost side of the second positive electrodes (122A) and the second negative electrodes (124A) in the predetermined direction. The interposed positive electrode (130A) is located between the first separator (116A) on the outermost side of the first stack (110A) and the second separator (126A) on the outermost side of the second stack (120A).

### TECHNICAL FIELD

The present invention relates to a battery cell.

### BACKGROUND ART

In recent years, various battery cells such as lithium-ion secondary batteries have been developed. The battery cell includes a battery element and an exterior member sealing the battery element. The battery element includes alternately stacked at least one electrode and at least one negative electrode, and a separator at least a part of which is located between the adjacent positive electrode and negative electrode.

Patent Document 1 discloses an example of a battery cell. This battery cell includes a plurality of superimposed stacking unit cells and a folded isolating film sheet interposed in the overlapping portion of the plurality of stacking unit cells.

Patent Document 2 discloses an example of a battery cell. This battery cell includes a plurality of superimposed wound battery elements.

Patent Document 3 discloses an example of a battery cell. This battery cell includes a solid-state battery stack. The tab is drawn upward from the substantially upper half portion of the solid-state battery stack. The tab is drawn downward from the substantially lower half portion of the solid-state battery stack.

### RELATED DOCUMENT

### Patent Document

Patent Document 1: PCT Japanese Translation Patent Publication No. 2017-530513

Patent Document 2: Japanese Unexamined Patent Publication No. 2003-234094

Patent Document 3: Japanese Unexamined Patent Publication No. 2018-129153

### SUMMARY OF THE INVENTION

### Technical Problem

To improve the energy density of the battery cell, a relatively large number of positive electrodes and negative electrodes need to be stacked in a single battery element. As the number of stacked positive electrodes and negative electrodes increases, however, the stack of the positive electrode or the negative electrode is likely to be displaced. As a result, it may be relatively difficult to sufficiently improve the energy density of the battery cell by simply increasing the number of stacked positive electrodes and negative electrodes.

An example of the object of the present invention is to easily increase the number of stacked positive electrodes and negative electrodes in a single battery element. Other objects of the present invention will become apparent from the description of the present specification.

### Solution to Problem

An aspect of the present invention is as follows.
[1] A battery cell including
   a plurality of stacks, each of the plurality of stacks including first electrodes, second electrodes and a separator, the first electrodes and the second electrodes being alternately stacked in a predetermined direction, the first electrodes and the second electrodes having different first polarity and second polarity respectively, at least a part of the separator covering the second electrode located on an outermost side of the first electrodes and the second electrodes in the predetermined direction, and
   an interposed electrode located between the separator on the outermost side of one of the plurality of stacks and the separator on the outermost side of another of the plurality of stacks, the interposed electrode having the first polarity.
[2] The battery cell according to [1],
   in which the separator is alternately folded back at a lateral portion of the first electrode of the predetermined direction and a lateral portion of the second electrode of the predetermined direction.
[3] The battery cell according to [1] or [2],
   in which the first electrodes, the second electrodes, and the separator of the one of the plurality of stacks are integrally held separately from the interposed electrode, and
   the first electrodes, the second electrodes, and the separator of the another of the plurality of stacks are integrally held separately from the interposed electrode.
[4] The battery cell according to [1] or [2],
   in which the first electrodes, the second electrodes, and the separator of the one of the plurality of stacks are integrally held together with the interposed electrode, and
   the first electrodes, the second electrodes, and the separator of the another of the plurality of stacks are integrally held separately from the interposed electrode.

### Advantageous Effects of Invention

According to the aspect described above of the present invention, the number of stacked positive electrodes and negative electrodes in a single battery element can be easily increased.

### BRIEF DESCRIPTION OF THE DRAWINGS

FIG. 1 A front perspective view of a battery cell according to Embodiment 1.

FIG. 2 An enlarged front perspective view of a portion of the battery cell according to Embodiment 1.

FIG. 3 A right side view of the battery cell according to Embodiment 1.

FIG. 4 A schematic cross-sectional view taken along line A-A of FIG. 3.

FIG. 5 A schematic cross-sectional view of a battery cell according to Embodiment 2.

### DESCRIPTION OF EMBODIMENTS

Hereinafter, an embodiment of the present invention will be described with reference to the drawings. In all drawings, the same constituent elements are denoted by the same reference signs, and detailed description thereof will not be repeated.

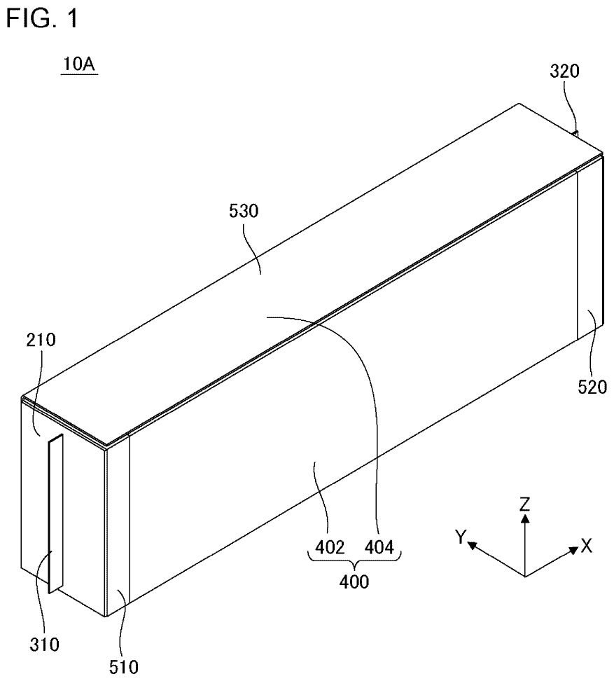

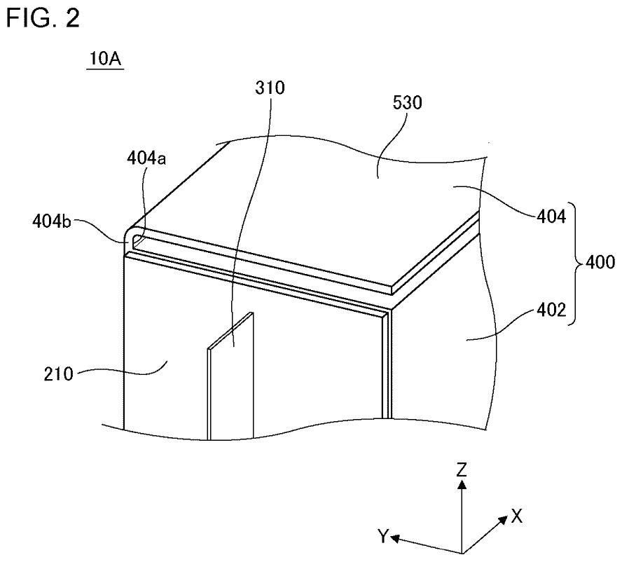

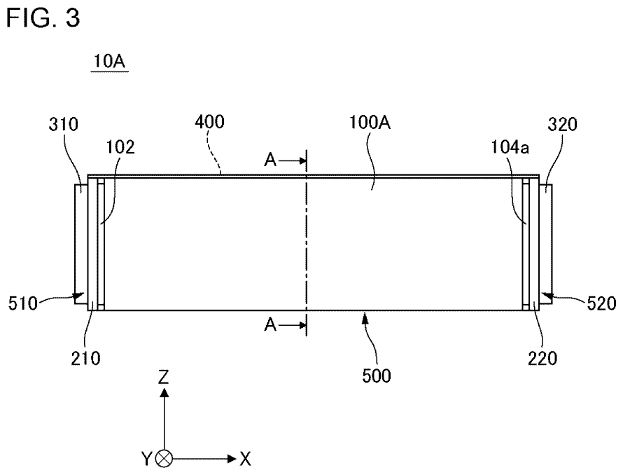

FIG. 1 is a front perspective view of a battery cell 10A according to Embodiment 1. FIG. 2 is an enlarged front perspective view of a part of the battery cell 10A according to Embodiment 1. FIG. 3 is a right side view of the battery cell 10A according to Embodiment 1. In FIG. 3, for the sake of description, an exterior film 400 is depicted as being transmitted.

In each figure, the X direction, the Y direction, and the Z direction are attached for description. The X direction indicates a front-rear direction of the battery cell 10A. The Y direction is orthogonal to the X direction. The Y direction indicates a left-right direction of the battery cell 10A. The Z direction is orthogonal to both the X direction and the Y direction. The Z direction indicates an up-down direction of the battery cell 10A. The direction indicated by the arrow indicating the X direction, the direction indicated by the arrow indicating the Y direction, and the direction indicated by the arrow indicating the Z direction are a rearward direction, a leftward direction, and an upward direction, respectively. The relationship between the X direction, the Y direction, the Z direction, the front-rear direction, the left-right direction, and the up-down direction of the battery cell 10A, however, is not limited to this example. The white circle with X indicating the X direction, the Y direction, or the Z direction indicate that the direction from the front to the back of the paper surface is the direction indicated by the arrow indicating the direction.

Hereinafter, the side indicated by the arrow indicating the X direction is referred to as a +X side as necessary.

Hereinafter, the opposite side of the side indicated by the arrow indicating the X direction is referred to as an −X side as necessary. Hereinafter, the side indicated by the arrow indicating the Y direction is referred to as a +Y side as necessary. Hereinafter, the opposite side to a side indicated by an arrow indicating the Y direction is referred to as a-Y side as necessary. Hereinafter, the side indicated by the arrow indicating the Z direction is referred to as a +Z side as necessary. Hereinafter, the opposite side to the side indicated by the arrow indicating the Z direction is referred to as a-Z side as necessary.

Hereinafter, the plane perpendicular to the X direction is referred to as a YZ plane as necessary. Hereinafter, the plane perpendicular to the Y direction is referred to as a ZX plane as necessary. Hereinafter, the plane perpendicular to the Z direction is referred to as an XY plane as necessary.

The battery cell 10A includes a battery element 100A, a front lid member 210, a rear lid member 220, a positive electrode tab 310, a negative electrode tab 320, and the exterior film 400. The exterior film 400 has a wound portion 402 and a drawn portion 404.

The battery element 100A has a substantially rectangular parallelepiped shape. The longitudinal direction of the battery element 100A is substantially parallel to the X direction. The lateral direction of the battery element 100A is substantially parallel to the Z direction. The thickness direction of the battery element 100A is substantially parallel to the Y direction.

The front lid member 210 covers the front end portion of the battery element 100A. The front lid member 210 is made of a resin such as polypropylene, for example. The front lid member 210 has a substantially rectangular shape as viewed from the front. As viewed from the front, the longitudinal direction of the front lid member 210 is substantially parallel to the Z direction, and the lateral direction of the front lid member 210 is substantially parallel to the Y direction.

The rear lid member 220 covers the rear end portion of the battery element 100A. The rear lid member 220 is made of a resin such as polypropylene, for example. The rear lid member 220 has a substantially rectangular shape as viewed from the rear. As viewed from the rear, the longitudinal direction of the rear lid member 220 is substantially parallel to the Z direction, and the lateral direction of the rear lid member 220 is substantially parallel to the Y direction.

The positive electrode tab 310 protrudes forward from the front lid member 210. The positive electrode tab 310 is electrically connected to a positive electrode current collector 102 drawn forward from a first positive electrode 112A and a second positive electrode 122A of the battery element 100A, which will be described later. As a result, the positive electrode tab 310 is electrically connected to the first positive electrode 112A and the second positive electrode 122A of the battery element 100A.

The negative electrode tab 320 protrudes rearward from the rear lid member 220. The negative electrode tab 320 is electrically connected to a negative electrode current collector 104 drawn rearward from a first negative electrode 114A and a second negative electrode 124A of the battery element 100A, which will be described later. As a result, the negative electrode tab 320 is electrically connected to the first negative electrode 114A and the second negative electrode 124A of the battery element 100A.

As shown in FIGS. 1 and 2, the wound portion 402 has a substantially tubular shape open toward both the front and the rear. The front lid member 210 is disposed inside the front opening of the wound portion 402. The rear lid member 220 is disposed inside the rear opening of the wound portion 402. The wound portion 402 is wound one turn around the X direction of the battery element 100A, the front lid member 210, and the rear lid member 220. Thus, the front lid member 210, the rear lid member 220, and the wound portion 402 form an accommodation space 500 that accommodates the battery element 100A. An electrolytic solution, not illustrated, is accommodated in the accommodation space 500 together with the battery element 100A. The aspect of the winding of the battery element 100A of the wound portion 402 is not limited to the example described above.

In the example shown in FIGS. 1 and 2, at least a part of the front surface of the front lid member 210 around the positive electrode tab 310 is exposed from the exterior film 400. The exterior film 400, however, may cover the front surface of the front lid member 210 around the positive electrode tab 310. Likewise, at least a part of the rear surface of the rear lid member 220 around the negative electrode tab 320 is exposed from the exterior film 400. The exterior film 400, however, may cover the rear surface of the rear lid member 220 around the negative electrode tab 320.

The outer peripheral surface of the front lid member 210 around the X direction and the inner peripheral surface of the front opening of the wound portion 402 around the X direction are joined to each other by thermal welding, for example. A front sealing portion 510 is formed accordingly. The outer peripheral surface of the rear lid member 220 around the X direction and the inner peripheral surface of the rear opening of the wound portion 402 around the X direction are bonded to each other by thermal welding, for example. A rear sealing portion 520 is formed accordingly.

As shown in FIGS. 1 and 2, the drawn portion 404 is drawn from the upper left corner of the battery element 100A of the wound portion 402 as viewed from the front. Specifically, as shown in FIG. 2, the drawn portion 404 includes a first drawn portion 404a and a second drawn portion 404b. The first drawn portion 404a is drawn from one of the opposite ends of the wound portion 402 in the circumferential direction around the X direction. The second drawn portion 404b is drawn from the other end of the opposite ends of the wound portion 402 in the circumferential direction around the X direction. The first drawn portion 404a and the second drawn portion 404b are joined to each other by thermal welding, for example. A side sealing portion 530 is formed accordingly. The drawn portion 404 is bent along the upper surface of the battery element 100A. The drawn portion 404, however, may not be bent. The bending shape of the drawn portion 404 is not limited to the shape according to Embodiment 1.

In Embodiment 1, the front end portion and the rear end portion of the battery element 100A are covered with two lid members. When both the positive electrode tab 310 and the negative electrode tab 320 are drawn out from the front end portion of the battery element 100A, however, the rear end portion of the battery element 100A may not be covered with the lid member and the front end portion of the battery element 100A may be covered with the lid member. That is, the lid member may cover only the side of the battery element 100A from which the positive electrode tab 310 and the negative electrode tab 320 are drawn. In this case, the exterior film 400 may be sealed and folded along the battery element 100A on the side of the battery element 100A opposite to the lid member.

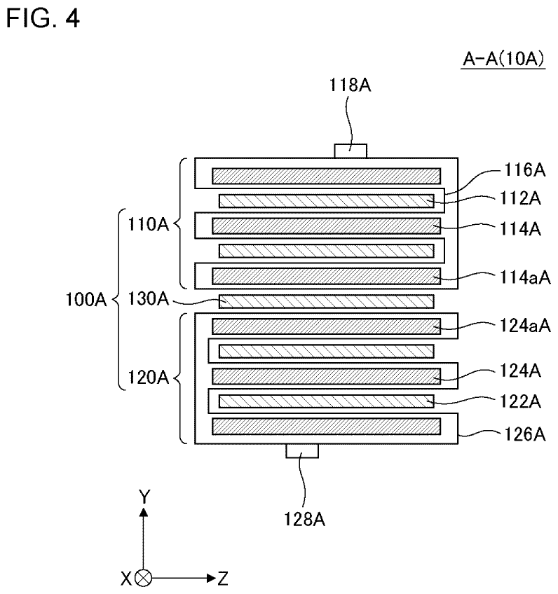

FIG. 4 is a schematic cross-sectional view taken along line A-A of FIG. 3.

The battery element 100A according to Embodiment 1 includes a first stack 110A, a second stack 120A, and an interposed positive electrode 130A. The first stack 110A and the second stack 120A are stacked on each other in the Y direction. The interposed positive electrode 130A is located between the first stack 110A and the second stack 120A in the Y direction. The first stack 110A has a plurality of first positive electrodes 112A, a plurality of first negative electrodes 114A, and a first separator 116A. The second stack 120A has a plurality of second positive electrodes 122A, a plurality of second negative electrodes 124A, and a second separator 126A.

The first stack 110A will be described. Hereinafter, unless otherwise specified, what applies to the first stack 110A also applies to the second stack 120A.

The plurality of first positive electrodes 112A and the plurality of first negative electrodes 114A are alternately stacked in the Y direction. Each of the first positive electrode 112A and the first negative electrode 114A has different polarities. The area of each first negative electrode 114A perpendicular to the Y direction is greater than the area of each first positive electrode 112A perpendicular to the Y direction. As viewed in the X direction, the Z-directional length of each first negative electrode 114A is longer than the Z-directional length of each first positive electrode 112A. In the example shown in FIG. 4, the first negative electrode 114A is located on the outermost opposite sides in the Y direction of the plurality of first positive electrodes 112A and the plurality of first negative electrodes 114A.

The first separator 116A has a substantially zigzag shape from the outermost +Y side to the outermost −Y side of the first stack 110A as viewed from the X direction. As a result, the first separator 116A is alternately folded at the lateral portion of the first positive electrode 112A of the Y direction and at the lateral portion of the first negative electrode 114A of the Y direction from the outermost +Y side to the outermost −Y side of the first stack 110A. Specifically, the first separator 116A is alternately folded at the +Z side portion of the first positive electrode 112A and at the −Z side portion of the first negative electrode 114A from the outermost +Y side to the outermost −Y side of the first stack 110A. As a result, between the +Z side portion of the first positive electrode 112A and the −Z side portion of the first negative electrode 114A, the first separator 116A passes through a region between the first positive electrode 112A and the first negative electrode 114A adjacent to each other in the Y direction. At least a part of the first separator 116A is therefore located between the first positive electrode 112A and the first negative electrode 114A adjacent to each other in the Y direction.

In the example shown in FIG. 4, the base end portion of the above substantially zigzag shape of the first separator 116A and the tip portion of the excess length portion of the above substantially zigzag shape of the first separator 116A are fixed to each other by a first fixing material 118A at the +Y side end portion of the first stack 110A. As a result, the plurality of first positive electrodes 112A, the plurality of first negative electrodes 114A, and the first separator 116A are integrally held by the first fixing material 118A. Specifically, the excess length portion of the first separator 116A is drawn from the outermost −Y side of the first stack 110A to the +Z side of the first stack 110A as viewed from the X direction. As viewed from the X direction, the excess length portion of the first separator 116A is bent toward the +Y side on the +Z side of the battery element 100A. As viewed from the X direction, the tip portion of the excess length portion of the first separator 116A is bent toward the −Z side at the +Y side end portion of the battery element 100A. As viewed from the X direction, at the outermost +Y side of the first stack 110A, the tip part of the excess length portion of the first separator 116A and the above base end part of the first separator 116A overlap each other in the Y direction and are fixed to each other by the first fixing material 118A. The first fixing material 118A is a tape, for example.

Next, the relationship between the first stack 110A, the second stack 120A, and the interposed positive electrode 130A will be described. Hereinafter, the first negative electrode 114A located on the outermost −Y side of the plurality of first positive electrodes 112A and the plurality of first negative electrodes 114A of the first stack 110A is referred to as a first outermost negative electrode 114aA as necessary. Hereinafter, the second negative electrode 124A located on the outermost +Y side of the plurality of second positive electrodes 122A and the plurality of second negative electrodes 124A of the second stack 120A is referred to as a second outermost negative electrode 124aA as necessary.

The first stack 110A is located on the +Y side with respect to the interposed positive electrode 130A. The first separator 116A covers the −Y side surface of the first outermost negative electrode 114aA on the outermost −Y side of the first stack 110A. As a result, the +Y side surface of the interposed positive electrode 130A and the −Y side surface of the first outermost negative electrode 114aA are separated from each other by a portion of the first separator 116A that covers the −Y side surface of the first outermost negative electrode 114aA. Accordingly, the electrochemical reaction of charging and discharging of the battery element 100A can occur between the +Y side surface of the interposed positive electrode 130A and the −Y side surface of the first outermost negative electrode 114aA.

The second stack 120A is located on the −Y side with respect to the interposed positive electrode 130A. The second separator 126A covers the +Y side surface of the second outermost negative electrode 124aA on the outermost +Y side of the first stack 110B. As a result, the −Y side surface of the interposed positive electrode 130A and the +Y side surface of the second outermost negative electrode 124aA are separated from each other by a portion of the second separator 126A that covers the +Y side surface of the second outermost negative electrode 124aA. Accordingly, the electrochemical reaction of charging and discharging of the battery element 100A can occur between the −Y side surface of the interposed positive electrode 130A and the +Y side surface of the second outermost negative electrode 124aA.

In Embodiment 1, the first stack 110A and the second stack 120A are separate stacks. That is, the first stack 110A can be operated alone as a battery element. The second stack 120A can also be operated alone as a battery element. In Embodiment 1, however, as described above, the electrochemical reaction of charging and discharging of the battery element 100A can occur both between the interposed positive electrode 130A and the first outermost negative electrode 114aA and between the interposed positive electrode 130A and the second outermost negative electrode 124aA. Accordingly, the first stack 110A, the second stack 120A, and the interposed positive electrode 130A can be operated as the single battery element 100A integrally.

In Embodiment 1, the first positive electrode 112A, the first negative electrode 114A, and the first separator 116A of the first stack 110A are integrally held separately from the interposed positive electrode 130A. The second positive electrode 122A, the second negative electrode 124A, and the second separator 126A of the second stack 120A are integrally held separately from the interposed positive electrode 130A. The total number of the first positive electrodes 112A and the first negative electrodes 114A included in the first stack 110A is less than the total number of the positive electrodes and the negative electrodes included in the battery element 100A. As a result, the first positive electrode 112A and the first negative electrode 114A can be easily alternately stacked in the Y direction in the first stack 110A as compared with the case where all the positive electrodes and the negative electrodes included in the battery element 100A are simply alternately stacked in the Y direction. Similarly, the total number of the second positive electrodes 122A and the second negative electrodes 124A included in the second stack 120A is less than the total number of the positive electrodes and the negative electrodes included in the battery element 100A. As a result, the second positive electrode 122A and the second negative electrode 124A can be easily alternately stacked in the Y direction in the second stack 120A as compared with the case where all the positive electrodes and the negative electrodes included in the battery element 100A are simply alternately stacked in the Y direction. Accordingly, the number of stacked positive electrodes and negative electrodes in the single battery element 100A can be easily increased as compared with the case where all the positive electrodes and the negative electrodes included in the battery element 100A are simply alternately stacked in the Y direction.

In Embodiment 1, both side portions of the interposed positive electrode 130A in the Z direction are not covered with the separator. That is, in the embodiment, the battery element 100A is formed by disposing the single interposed positive electrode 130A without disposing another stack between the first stack 110A and the second stack 120A. Therefore, the battery element 100A can be easily formed as compared with a case where another stack is disposed between the first stack 110A and the second stack 120A.

In Embodiment 1, the first fixing material 118A is not disposed between the first stack 110A and the interposed positive electrode 130A in the Y direction. Specifically, the first fixing material 118A is disposed on the +Y side of the first stack 110A. If the first fixing material 118A is disposed between the first stack 110A and the interposed positive electrode 130A in the Y direction, there is a possibility that the first fixing material 118A affects the electrochemical reaction between the interposed positive electrode 130A and the first outermost negative electrode 114aA. The influence of the first fixing material 118A on the electrochemical reaction can be suppressed, on the other hand, when the first fixing material 118A is not disposed between the first stack 110A and the interposed positive electrode 130A in the Y direction. The first fixing material 118A may be disposed on the +Z side or the −Z side of the first stack 110A instead of the +Y side of the first stack 110A. In this case, the influence of the first fixing material 118A on the above electrochemical reaction can be also suppressed. The same applies to a second fixing material 128A.

In Embodiment 1, as viewed from the X direction, the first separator 116A of the first stack 110A is alternately folded at the +Z side portion of the first positive electrode 112A and the −Z side portion of the first negative electrode 114A. The first stack 110A, however, may have a plurality of substantially sheet-shaped separated first separators 116A instead of the first separator 116A according to Embodiment 1. Each of the plurality of first separators 116A is located between the first positive electrode 112A and the first negative electrode 114A adjacent to each other in the Y direction. The same applies to the second separator 126A of the second stack 120A.

In Embodiment 1, the interposed positive electrode 130A is located as the interposed electrode between the first separator 116A on the outermost −Y side of the first stack 110A and the second separator 126A on the outermost +Y side of the second stack 120A. An interposed negative electrode may be, however, located as the interposed electrode between the first separator 116A on the outermost −Y side in the first stack 110A and the second separator 126A on the outermost +Y side in the second stack 120A. In this example, the first separator 116A covers, on the outermost −Y side of the first laminate 110A, the −Y side surface of the first positive electrode 112A located on the outermost −Y side of the plurality of first positive electrodes 112A and the plurality of first negative electrodes 114A. As a result, the polarity of the interposed negative electrode and the polarity of the electrode located on the outermost −Y side of the first stack 110A are different from each other. The second separator 126A covers, on the outermost +Y side of the second stack 120A, the +Y side surface of the second positive electrode 122A located on the outermost +Y side of the plurality of second positive electrodes 122A and the plurality of second negative electrodes 124A. As a result, the polarity of the interposed negative electrode and the polarity of the electrode located on the outermost +Y side of the second stack 120A are different from each other. In this example, the first stack 110A, the second stack 120A, and the interposed positive electrode 130A can be also operated as the single first stack 110A integrally for the same reason as described in the embodiment.

In Embodiment 1, the battery cell 10A includes two stacks of the first stack 110A and the second stack 120A, and one interposed electrode of the interposed positive electrode 130A. The battery cell 10A, however, may include three or more stacks and two or more interposed electrodes. In this example, each interposed electrode is located between two stacks stacked in the Y direction.

Next, an example of a method of manufacturing the battery element 100A will be described.

First, the first stack 110A is formed. For example, a plurality of first positive electrodes 112A and a plurality of first negative electrodes 114A are alternately arranged in the Y direction on the first separator 116A bent in a substantially zigzag shape as viewed from the X direction. Next, the first fixing material 118A integrally holds the plurality of first positive electrodes 112A, the plurality of first negative electrodes 114A, and the first separator 116A. The method of forming the first stack 110A, however, is not limited to this example.

The second stack 120A is formed in the same way as the first stack 110A at the same time as, before, or after the first stack 110A is formed.

Next, the first stack 110A and the second stack 120A are stacked with each other in the Y direction with the interposed positive electrode 130A disposed between the first stack 110A and the second stack 120A in the Y direction. As a result, the battery element 100A is manufactured.

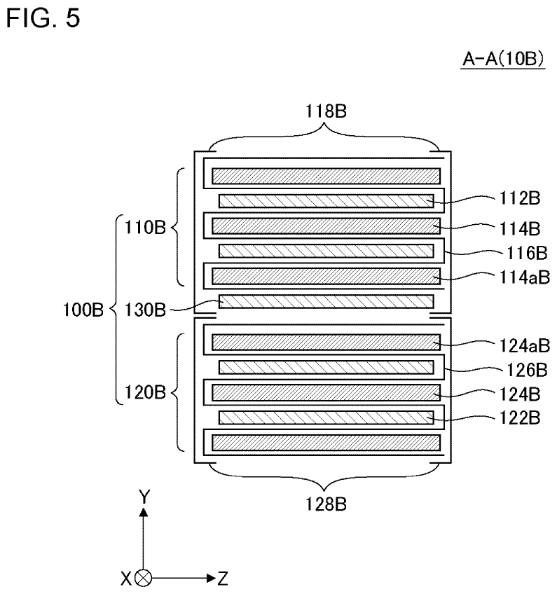

FIG. 5 is a schematic cross-sectional view of a battery cell 10B according to Embodiment 2. The battery cell 10B according to Embodiment 2 is the same as the battery cell 10A according to Embodiment 1 except for the following points.

A battery element 100B according to Embodiment 2 has a first stack 110B, a second stack 120B, and an interposed positive electrode 130B. The first stack 110B includes a plurality of first positive electrodes 112B, a plurality of first negative electrodes 114B, and a first separator 116B. The second stack 120B includes a plurality of second positive electrodes 122B, a plurality of second negative electrodes 124B, and a second separator 126B.

The plurality of first positive electrodes 112B, the plurality of first negative electrodes 114B, the first separator 116B are integrally held together with the interposed positive electrode 130B by a pair of first fixing materials 118B. The pair of first fixing materials 118B are provided on both sides of the first stack 110B and the interposed positive electrode 130B in the Z direction. Each first fixing material 118B is a tape, for example.

The plurality of second positive electrodes 122B, the plurality of second negative electrodes 124B, and the first separator 116B are integrally held by a pair of second fixing materials 128B separately from the interposed positive electrode 130B. The pair of second fixing materials 128B are provided on both sides of the second stack 120B in the Z direction. Each second fixing material 128B is a tape, for example.

In Embodiment 2, the +Y side surface of the interposed positive electrode 130B and the −Y side surface of a first outermost negative electrode 114aB are also separated from each other by a portion of the first separator 116B that covers the −Y side surface of the first outermost negative electrode 114aB. The −Y side surface of the interposed positive electrode 130B and the +Y side surface of a second outermost negative electrode 124aB are separated from each other by a portion of the second separator 126B that covers the +Y side surface of the second outermost negative electrode 124aB. Similarly to Embodiment 1, the number of stacked positive electrodes and negative electrodes in the single battery element 100B can be therefore easily increased as compared with the case where all the positive electrodes and the negative electrodes included in the battery element 100B are simply alternately stacked in the Y direction.

While the embodiments of the present invention have been described with reference to the drawings, these are only exemplification of the present invention, and various configurations other than the embodiments described above can also be employed.

This application claims priority based on Japanese Patent Application No. 2022-201916 filed on Dec. 19, 2022, the disclosure of which is incorporated herein in its entirety by reference.

### REFERENCE SIGNS LIST

10A, 10B battery cell, 100A, 100B battery element, 102 positive electrode current collector, 104 negative electrode current collector, 110A, 110B first stack, 112A, 112B first positive electrode, 114A, 114B first negative electrode, 114aA, 114aB first outermost negative electrode, 116A, 116B first separator, 118A, 118B first fixing material, 120A, 120B second stack, 122A, 122B second positive electrode, 124A, 124B second negative electrode, 124aA, 124aB second outermost negative electrode, 126A, 126B second separator, 128A, 128B second fixing material, 130A, 130B interposed positive electrode, 210 front lid member, 220 rear lid member, 310 positive electrode tab, 320 negative electrode tab, 400 exterior film, 402 wound portion, 404 drawn portion, 404a first drawn portion, 404b second drawn portion, 500 accommodation space, 510 front sealing portion, 520 rear sealing portion, 530 side sealing portion

1. A battery cell comprising:
a plurality of stacks, each of the plurality of stacks including first electrodes, second electrodes and a separator, the first electrodes and the second electrodes being alternately stacked in a predetermined direction, the first electrodes and the second electrodes having different first polarity and second polarity respectively, at least a part of the separator covering the second electrode located on an outermost side of the first electrodes and the second electrodes in the predetermined direction; and
an interposed electrode located between the separator on the outermost side of one of the plurality of stacks and the separator on the outermost side of another of the plurality of stacks, the interposed electrode having the first polarity.

2. The battery cell according to claim 1,
wherein the separator is alternately folded back at a lateral portion of the first electrode of the predetermined direction and at a lateral portion of the second electrode of the predetermined direction.

3. The battery cell according to claim 1,
wherein the first electrodes, the second electrodes, and the separator of the one of the plurality of stacks are integrally held separately from the interposed electrode, and
the first electrodes, the second electrodes, and the separator of the another of the plurality of stacks are integrally held separately from the interposed electrode.

4. The battery cell according to claim 1,
wherein the first electrodes, the second electrodes, and the separator of the one of the plurality of stacks are integrally held together with the interposed electrode, and
the first electrodes, the second electrodes, and the separator of the another of the plurality of stacks are integrally held separately from the interposed electrode.
